(19) United States
(12) Patent Application Publication
(10) Pub. No.: US 2009/0316864 A1
(43) Pub. Date: Dec. 24, 2009

(54) System And Method For Capturing Audio Content In Response To Questions

(76) Inventor: Jeff Fitzsimmons, Fox Point, WI (US)

Correspondence Address: BOYLE FREDRICKSON S.C., 840 North Plankinton Avenue, MILWAUKEE, WI, 53203, US

(21) Appl. No.: 12/144,412

(22) Filed: Jun. 23, 2008

(51) Int. Cl. H04M 11/00; G06Q 10/00; G06F 3/16

(52) U.S. Cl. 379/88.13; 705/7; 715/716; 715/738

(57) ABSTRACT

A computer-implemented method for conducting an interview session using a telephony system. The method includes establishing an interviewer telephone call, recording one or more interview questions to create an interview questions file during the interviewer telephone call, and posting the interview questions file on a computer implemented graphical interface to allow one or more interviewees to access the interview questions file. The method further includes establishing an interviewee telephone call, providing the recorded interview questions during the interviewee telephone call and recording at least a portion of the interviewee telephone call to generate an interview response file, and posting the interview response file on the computer implemented graphical interface to allow one or more interviewers to access the interview response file.

### FIELD

The present invention relates to systems and methods for conducting telephonic interview sessions. Specifically, the present invention relates to a system and method for conducting a telephonic interview including capturing audio content provided in response to questions asked during the interview.

### BACKGROUND

Interactive question and answer sessions are an often used method for obtaining data. The interactive sessions usually take to form of a question and answer session. A respondent is provided with a series of questions from a questioner to which they are asked to provide responses. These responses or the content of these responses can be used to obtain the data sought by the questioner

One type of interactive question and answer session is an interview. In an interview, the questioner is attempting to ascertain as much information as possible from a respondent within a limited period of time. The interview may be between a hiring manager and an applicant, between a customer and supplier, between a teacher and a student, as part of a dating service, etc.

Conventional interviewing requires scheduling a time when both participants are available at a location usually associated with the questioner. In person interviewing requires that the respondent travel to the location of the questioner. A telephone interview solves the problem of travelling to a single location, but still requires that the questioner and respondent coordinate their schedules. This coordination may be particularly difficult where there are multiple questioners for the respondent to talk with, as is often the case with, for example, an interview.

Coordination may difficulties may be lessened by having the questioners provide their questions to the respondent to complete at their leisure. However, the answers obtained to questions where the respondent is provided with a long response time may vary significantly from questions that require an instantaneous response. In order to obtain unfiltered answers from a respondent, it is often valuable to avoid having the respondent know what questions are being asked before they are actually asked.

What is needed is an interviewing system and method for implementing a question and answer session using a telephony system where the interviewing system is configured to capture and store the responses to the questions received during a telephone call in an audio file. What is further needed is such a system and method configured to allow questioners to record a plurality of questions for later provision during the telephone call.

### SUMMARY

A computer-implemented method for conducting an interview session using a telephony system is described. The method includes establishing an interviewer telephone call, recording one or more interview questions to create an interview questions file during the interviewer telephone call, and posting the interview questions file on a computer implemented graphical interface to allow one or more interviewees to access the interview questions file. The method further includes establishing an interviewee telephone call, providing the recorded interview questions during the interviewee telephone call and recording at least a portion of the interviewee telephone call to generate an interview response file, and posting the interview response file on the computer implemented graphical interface to allow one or more interviewers to access the interview response file.

The method may further include providing a comment function on the graphical user interface to allow the one or more interviewers to provide comments to be associated with the interview response file. The comment function may be used to implement an incremental rating system ranking the interview response file relative to other interview response files displayed on the computer-implemented graphical user interface. The comment function may also be configured to allow a user to initiate at least a third telephone call to provide additional audio content to be associated with the interview response file. The comment function may yet further be configured to increase or decrease an interviewee rating associated with the creator of the interview response.

The automated interview function may also include transmitting an invitation to one or more interviewees based on the posting of the interview questions file, the invitation including a link to facilitate establishing the interviewee telephone call.

Other features and advantages of the invention will become apparent to those skilled in the art from the following detailed description and accompanying drawings. It should be understood, however, that the detailed description and specific examples, while indicating the preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout, and in which:

FIG. 1 is a computer-implemented interviewing environment for capturing answers in a question and answer session using a telephony system, according to an exemplary embodiment;

FIG. 2 is a flowchart illustrating a method for creating an interview to be conducted using the telephony system of FIG. 1, according to an exemplary embodiment;

FIG. 3 is a flowchart illustrating a method for utilizing system to provide recorded answer to interview questions using a telephony system, according to an exemplary embodiment; and

FIG. 4 is a computer implemented graphical interface for reviewing, sharing, and providing comments on displayed interview response files, according to an exemplary embodiment.

Before explaining embodiments of the invention in detail, it is to be understood that the invention is not limited in its application to the details of construction and the arrangement of the components set forth in the following description and illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION

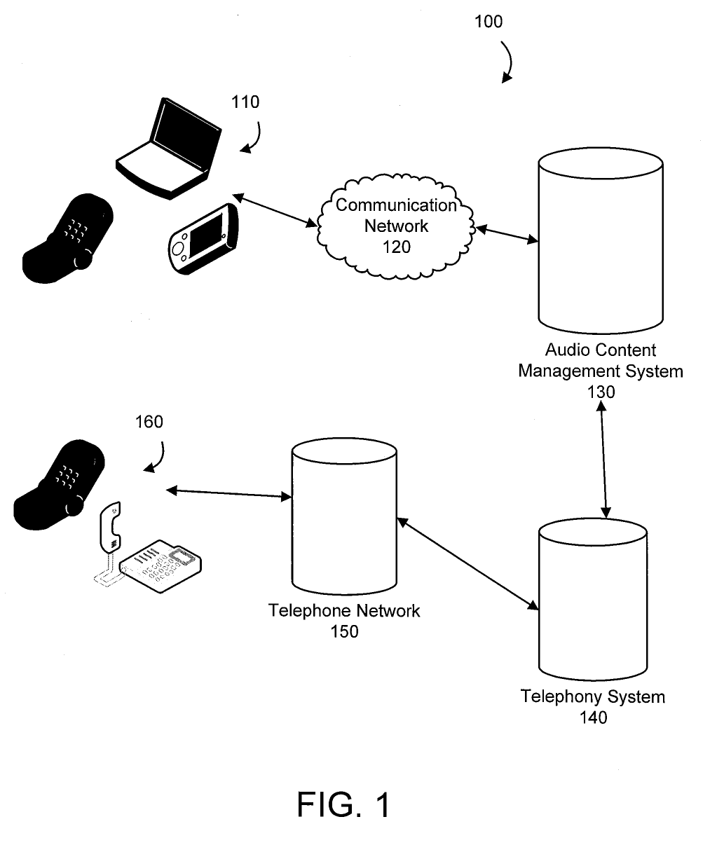

Referring now to FIG. 1, a computer-implemented interviewing environment 100 for capturing answers in a question and answer session using a telephony system is shown, according to an exemplary embodiment. Interviewing environment 100 is configured include a user computing system 110 connected to a computer-implemented interviewing system 130 through a communication network 120, such as the Internet. Computer-implemented interviewing system 130 is further connected to a telephone network 150 through a telephony system 140 configured to allow interviewing system 130 to implement an audio communication channel with a user through a user telephone device 160. Although system 100 is shown and described as including particular systems and device in a particular configuration, it should be understood that system 100 may alternatively include more, less, and/or a different configuration of devices and systems configured to implement the functionality described herein.

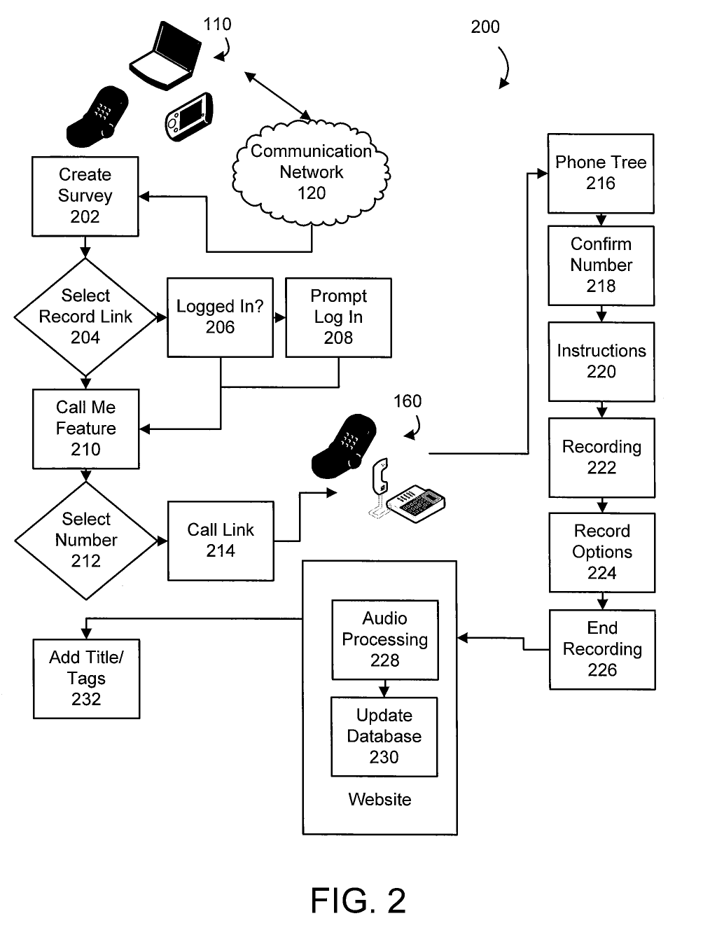

Computer system 110 is representative of the wide range of large and small computer systems that are used in computer networks of all types. For example, computer system 110 may be a desktop computing system, a laptop communication system, a handheld computing device, a smart phone, or any other web-enabled computing device configurable to allow a user to access system 130 using communication network 120 and initiate an interviewing method, described below in further detail with reference to FIGS. 2-4. Although only a single computing system 110 is shown in FIG. 1, it should be understood that the method and system described herein may be used to connect system 130 to a larger number of different systems 110 and device 160.

Communication network 120 is intended to be representative of the complete spectrum of computer network types including Internet and internet-like networks. Communication network 120 may be utilized to allow communication between system 130 and any number of computer systems, of which computer system 110 is representative.

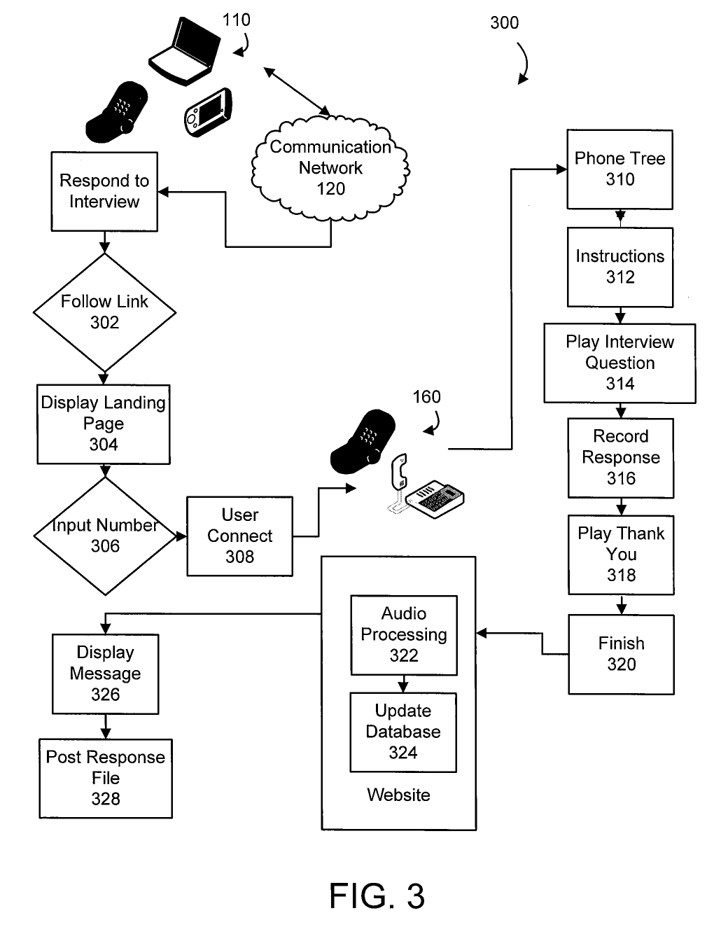

Computer-implemented interviewing system 130 may be implemented using any of a variety of computing systems configured to implement a web server function and a telephony system service. Interviewing system 130 is configured to implement functionality allowing a user to access system 130 using their computer system 110 to initiate or conduct a telephonic interview using telephony system 140, described below in detail with reference to FIGS. 2 and 3. Interviewing system 130 may further be configured to implement a web-based interface for managing accounts, recording and managing survey and/or interviewing questions, accessing and reviewing new and archived survey audio content provided in response to surveys or screening interviews and collaborating with other users.

Telephony system 140 is a system configured to allow system 130 to initiate and record a telephone interview with a user through device 160 using computer telephone integration CTI software and telephony hardware. CTI software enables computer system 130 to know about and control phone functions such as making and receiving voice, fax, and data calls with telephone directory services and caller identification. According to one exemplary embodiment, telephony system 140 and interviewing system 130 may be implemented using a single computing system.

The CTI software may be configured as an interface between system 130 and the telephone network 150. The software translates commands entered by a user into a website hosted by system 130 into commands that trigger telephony hardware. This functionality allow system 130 to call users (or allows the users to call system 130), and initiate system 130 to record the audio being provided through a device 160.

Telephony hardware may include any type of hardware configured to allow system 130 to connect to a plurality of devices 160 over a telephone network 150. The hardware may consist on Session Border Controller (SBC) clusters, routing clusters and media gateways, as are generally known in the art.

Telephone network 150 may be any telephone network such as the Public Switched Telephone Network (PSTN), the network of the world's public circuit-switched telephone networks. Telephone network 150 is configured to allow audio and data to be transmitted and received between system 130 and devices 160.

User telephone device 160 may include any type of device configured to allow a user to receive a telephone call from system 130. Exemplary devices may include, but are not limited to telephones, mobile phones, VOIP (or similar) devices, etc. Although a single connection and two devices 160 are shown, it should be understood that system 130 may be configured to allow connections to a large number of devices 160 through a large number of telephone connections.

In operation, environment 100 may be utilized to conduct and capture the spontaneous results of an interview session without requiring coordination of the participants. An interview may be a user that creates a management account using interviewing system 130 and records a series of questions that will be played back to one or more interviewees in order to record their answers for later review. An interviewee may be a user that is invited to participate in an automated survey and screening method. The interviewee is invited to hear and respond to questions from one or more interviewers.

According to one exemplary embodiment, interviewing system 130 may be configured to implement user-generated, automated screening, surveying, and interviewing. System 130 allows users to create a series of questions by telephone, computer or mobile device. The questions may then be present to a large number of respondents who can respond to the questions by telephone, computer or mobile device. The responses may be recorded and present back to the questioners or other persons conducting the interview or survey. The automated system allows interviewing system 130 to interview, screen, or otherwise survey, large numbers of respondents and preserve their responses accurately and efficiently.

Although the above system and method is described with reference to capturing and otherwise utilizing audio content, one of ordinary skill in the art would understand that system 130 may also be utilized with recording video content of interviews and/or responses. The video may be recorded, for example, through the website of system 130 or over a video enabled mobile device 160.

Referring now to FIG. 2, a flowchart 200 illustrating a method for creating an interview to be conducted using telephony system 140 is shown, according to an exemplary embodiment. An interviewer may utilize system 130 to create the interview or survey. The method of flowchart 200 may be used to record a series of questions for the interview or survey to be used by interviewing system 130. To initiate the interview creation process, an interviewer can utilize their computing system 110 to log in to a website associated with system 130 in a step 202 and initiate a new survey/screening interview. In a step 204, the user selects a link to initiate the automated recording process. The link may be displayed to the user on a web page hosted by system 130 and displayed on computing system 110.

System 130 may be configured to verify the identity of the interviewer by checking if the interviewer is currently logged in to system 130 in a step 206. If the interviewer is not currently log in, system 130 is configured to prompt new to log in or, if the interviewer is a new user, to create an account in a step 208.

Following verification, a web page including a “Call Me” link is displayed to the user in a step 210. The interviewer may select the link when the have their questions prepared and are ready to begin recording. According to an alternative embodiment, the user may record the questions without using a computer system 110 initially by calling a designated telephone number associated with telephony system 140 and enter, for example, a unique ID number or other identifier.

Upon selection of the “Call Me” link, the user can be provided with a listing a previously entered telephone numbers associate with the user account in a step 212. The user may also be provided with an option to enter a new phone number. The user is provided with instructions that the phone number provided should be the number of a phone at the interviewer's current location on which they are prepared to receive a phone call from system 130.

In a step 214, the user initiates the phone call from their computing device 110 by selecting a “Make Call” link. Selecting the link prompts system 130 to connect to the selected telephone number of a device 160 through telephony system 140. The user telephone device receives the call from system 130 to create an audio connection to system 130. System 130 may be configured to display one or more status messages on the web page being displayed on computing system 110 based on the status of the audio connection. Exemplary messages may include “calling,” “answered,” “recording,” completed,” etc.

Once the user is connected to system 130 through telephony system 140, system 140 may be configured to guide the user through a phone tree in a step 216 which provides the user with a variety of recorded messages and options that will facilitate recording of the survey or interview questions.

In a step 218, upon answering of the call by the user, system 130 may be configured to confirm the telephone number, particularly where system 130 has not previously accessed the phone number. System 130 may be configured to play a recorded message asking the user to press a specified key to confirm that system 130 may use the telephone number.

Upon confirmation, system 130 may be configured to play a recorded welcoming message. The welcoming message may be configured to include a system identification, instructions in a step 220, promotional information, account information, etc.

Following the provided instructions, the user may record their survey or interview questions in a step 222 by speaking normally into their telephone device 160. Once the user is finished recording, system 130 may be configured to provide the user with a plurality of options for handling the recorded questions in a step 224. Options may include reviewing, re-recording, submitting, etc. Upon completion of the survey or interview questions recording, the user may end the phone call in a step 226.

System 130 may be configured to process the recorded questions in a step 228. Processing the audio content may include converting the recorded questions to the website presentation format, cleaning the audio content to remove white noise, background noise, etc., and posting the user generated audio content on the website. System 130 may further add the processed user generated audio content to a database associated with system 130 in a step 230.

Following posting of the generated audio content, system 130 may be configured to prompt the user for additional information regarding the recorded questions through a web page displayed on computing system 110 in a step 232. The additional information may include a title for the generated questions as well as additional information. The title and other additional information may alternatively be provided during the phone call and converted to text by a human representative, speech to text recognition software, etc.

After receiving the title and additional information, the record questions may be posted as a completed interview file on the website associated with system 130 in a step 236 such that the interview may be accessed using system 130. According to an exemplary embodiment, system 130 may be configured to implement an invitation function allowing the users to email or otherwise provide interviewees with a link to the completed interview file such that they can initiate their own audio connection to hear the interview questions and provide their responses, as described in further detail below.

Referring now to FIG. 3, a flowchart 300 illustrating a method for utilizing system 130 to provide recorded answer to interview questions using a telephony system 140 is shown, according to an exemplary embodiment. Following completion of the interview file described above with reference to FIG. 2, an interviewee may access the interview file respond to the interview or survey. The interviewee may use system 130 to record a series of responses to the interviewer questions. The interviewer will then be able to access the recorded responses, review the responses, share them with colleagues, etc.

In a step 302, the interviewee may use a computing system 110 to select a link to respond to the interviewer invitation. Accessing the link displays a webpage hosted by system 130 in a step 304 that is configured to receive a telephone number from the interviewee in a step 306. According to an alternative embodiment, the invitation may include a designated telephone number associated with telephony system 140 to allow the interviewee to call system 130 directly and enter a unique identifier that can also be provided in the invitation.

In a step 308, system 130 calls the provided telephone number of a device 160 to initiate the telephone connection. During the telephone connection, the website may again be configured to display one or more status messages.

Once the user is connected to system 130 through telephony system 140, system 140 may be configured to guide the user through a phone tree in a step 310 which provides the interviewee with a variety of recorded messages and options that will facilitate playback of the interview questions and recording of the survey or interview responses.

In a step 312, system 130 may be configured to play a recorded welcoming message. The welcoming message may be configured to include instructions for completing the interview process.

Following the provided instructions, system 130 may be configured to provide an interview question, the interview question being the recorded audio generated as described above with reference to FIG. 2 in a step 314. The interviewee may record their response to the interview question in a step 316 by speaking normally into their telephone device 160. System 130 maybe configured to iteratively perform steps 314 and 316 for each of the recorded audio questions. Upon completion of the survey or interview question, system 130 may be configured to provide an interview thank you message in a step 318 and the user may end the phone call in a step 320.

System 130 maybe configured to process the recorded questions in a step 322 similar to step 228 described above with reference to FIG. 2. System 130 may further add the processed complete interview response file to a database associated with system 130 in a step 324.

Following posting of the generated audio content, system 130 may be configured to display concluding information thanking the interviewee for submitting their response one a web page displayed on computing system 110 in a step 326. The recorded responses may be posted as a completed interview response file on the website associated with system 130 in a step 328 such that the interviewer may access the file using system 130.

Although a particular series of steps are shown and described in a particular order in the flowcharts shown in FIGS. 2 and 3 and described above, it should be understood that the methods described with reference to these flowchart may be implemented using more, fewer, and/or a different ordering of the steps to perform the functions described therein.

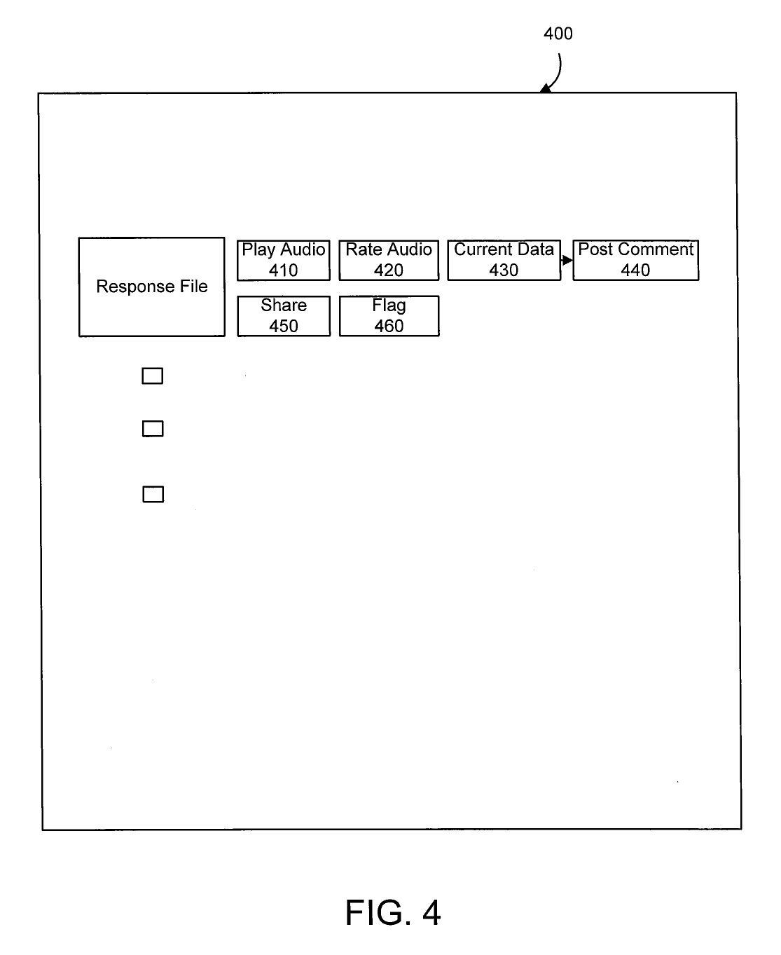

Referring now to FIG. 4, a computer implemented graphical interface 400 for reviewing, sharing, and providing comments on displayed interview response files is shown, according to an exemplary embodiment. Interface 400 is configured to allow the response file to be shared and reviewed by interested parties. Graphical interface 400 may be implemented using a web page created using hypertext markup language (HTML) or other language codes to implement the functions described hereinbelow.

Graphical interface 400 may be configured to display a plurality of user generated audio content files, the display including a link to the audio file that will launch an audio player and play back the audio file. The display may further include the title and content filter rating supplied by the creator, a current rating, associated user comments, etc. Each audio content file may be associated with a plurality of links including a play audio link 410, a rate audio link 420, a view current data link 430, a post comment link 440, a share link 450, and a flag material link 460. Each of the described functions and methods may be associated with one or more user selectable icons, hyperlinks, text entry fields, images, text displays, embedded applications, etc.

Play audio link 410 may be configured to allow users to listen to the interview response file using a player presented by system 130. The audio file may alternatively be played through embedded players designed to reside on personal websites, blogs, social networking sites, etc. Audio files may also be played through desktop widgets, mobile devices, cellphones, etc.

Rate response link 420 may be configured to allow interviewers to rate the quality of the responses to the interview questions. The review system may include any of a variety of rating systems and methods. For example, system 130 may be configured to implement an incremental rating system such that each vote is a vote for hiring or otherwise selecting the interviewee associated with the response file. Each vote increases the ranking of the selected audio content relative to other interviewees associated with system 130. Accordingly, the interviewers using system 130 will be able to collectively identify quality interviewees or response files for other content viewers.

View current data link 430 may be configured to allow an interviewer to display any data associated with the response file, including both user generated information and information generated by system 130 and/or other interviewers. The displayed data may include, but is not limited to, a resume of the interviewee, a potential start date, etc.

Post comment link 440 allows a content viewer to provide feedback on the selected interview response file. The feedback may include text comments, a scale rating, selection of a positive or negative rating, etc. According to an exemplary embodiment, the post comment link 440 may also allow a user to provide their comments as a second audio content file to be associated with the selected interview response file. Advantageously, allowing follow on interview responses may allow users to tell their own stories related to a particular interview question file or an interview response file. Examples can include genealogical information where all family members are invited to tell stories regarding a great grandmother, etc. Different and conflicting audio content may be submitted regarding a particular event to describe a historical event, etc.

Yet another application may include collaborative fiction, wherein the first interview question is an introductory theme or a start to a story. Responses to the question may include extensions to the story which may in turn be treated as interview questions to allow responses and/or audio comments to further extend the fictional creation. Advantageously, interviewing system 130 may be used to create a collaborative story in which each respondent further extends the created work, adds their own perspective regarding a news story or other topic, adds their own story regarding a relative, etc.

Share link 450 allows a user to select from a plurality of methods for sharing the selected interview response. Sharing methods may include multiple social networking submission buttons that allow users to easily submit links to individual interview responses to a network or colleagues, a human resource group, or any other defined group. Sharing may also include emailing links to individual interview response files, either to an individual identified by a specific email address or to an entire address book associated with the interviewer.

Flag material link 460 allows a user to suggest a modification to the information associated with the audio content file. The modification may include additional tags, content filter indicators, etc.

As described above with reference to FIG. 4, system 130 can be use to facilitate conducting and sharing the results of any type of question and answer session. System 130 can be used by employers to pre-screen job applicants before spending time and money to schedule and conduct in person interviews. The employer can create interview questions designed to determine personality and business culture fit. Since all interviewee are responding to the exact same questions, the process is standardized to provide a more accurate initial assessment. Additionally, since the responses are necessarily spontaneous and audible, the responses include valuable information such as the speed of response, tone, inflection, confidence, etc

Further, the ability to review the response at any time and to allow colleagues to do the same, will allow companies to better manage group hiring without consuming a large amount of time. These responses can also be archived for future hiring needs, lawsuit protection, etc.

Although described within the context of group hiring, the above described system and method can be used for identifying best responses to any type of question, such as which interviewee had the best story, which interviewee submitted the most creative responses, etc. System 130 could be used as a component for a dating website, allowing potential dates to answer a series of question posed by an interviewer such that the interviewer can select the interviewee with the most interesting/compatible answers for a date. System 130 may also be used as a component in conducting consumer survey or focus groups to allow customers or organizations to record customized surveys or focus group questions for mass distribution.

System 130 may yet further be used as a component to a genealogy study. System 130 allows individuals to record interviews to elicit stories or family-related responses from family members or friends of family members. The interviewer can then post the stories/responses on their website or other genealogy related sites so that future generations can enjoy the audible or video responses of the stories being conveyed.

Various alternatives are contemplated as being within the scope of the following claims particularly pointing out and distinctly claiming the subject matter regarded as the invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

It is claimed:

1. A computer-implemented method for conducting an interview session using a telephony system, comprising:
(a) establishing an interviewer telephone call;
(b) recording one or more interview questions to create an interview questions file during the interviewer telephone call;
(c) posting the interview questions file on a computer implemented graphical interface to allow one or more interviewees to access the interview questions file;
(d) establishing an interviewee telephone call;
(e) providing the recorded interview questions during the interviewee telephone call and recording at least a portion of the interviewee telephone call to generate an interview response file; and
(f) posting the interview response file on the computer implemented graphical interface to allow one or more interviewers to access the interview response file.

2. The method of claim 1, further including providing a comment function on the graphical user interface to allow the one or more interviewers to provide comments to be associated with the interview response file.

3. The method of claim 2, wherein the comment function is configured to implement an incremental rating system ranking the interview response file relative to other interview response files displayed on the computer-implemented graphical user interface.

4. The method of claim 2, wherein the comment function is configured to allow a user to initiate at least a third telephone call to provide additional audio content to be associated with the interview response file.

5. The method of claim 2, wherein the comment function is configured to increase or decrease an interviewee rating associated with the creator of the interview response.

6. The method of claim 1, further including transmitting an invitation to one or more interviewees based on the posting of the interview questions file, the invitation including a link to facilitate establishing the interviewee telephone call.

7. The method of claim 1, further including receiving information to be associated with the interview response file through the graphical user interface.

8. A computer-implemented system for generating audio content using a telephony system, comprising:
a telephony system configured to establish a telephone call based on instructions received from a computer system; and
an automated interview system configured to perform a plurality of steps to automatically conduct an interview session using the telephony system, including
(a) establishing an interviewer telephone call using the telephony system,
(b) recording one or more interview questions to create an interview questions file during the interviewer telephone call,
(c) posting the interview questions file on a computer implemented graphical interface to allow one or more interviewees to access the interview questions file,
(d) establishing an interviewee telephone call using the telephony system,
(e) providing the recorded interview questions during the interviewee telephone call and recording at least a portion of the interviewee telephone call to generate an interview response file, and
(f) posting the interview response file on the computer implemented graphical interface to allow one or more interviewers to access the interview response file.

9. The method of claim 8, wherein the computer system is further configured to provide a comment function on the graphical user interface to allow the one or more interviewers to provide comments to be associated with the interview response file.

10. The method of claim 9, wherein the comment function is configured to implement an incremental rating system ranking the interview response file relative to other interview response files displayed on the computer-implemented graphical user interface.

11. The method of claim 9, wherein the comment function is configured to allow a user to initiate at least a third telephone call to provide additional audio content to be associated with the interview response file.

12. The method of claim 9, wherein the comment function is configured to increase or decrease an interviewee rating associated with the creator of the interview response.

13. The method of claim 8, wherein the computer system is further configured to transmit an invitation to one or more interviewees based on the posting of the interview questions file, the invitation including a link to facilitate establishing the interviewee telephone call.

14. The method of claim 8, wherein the computer system is further configured to receive information to be associated with the interview response file through the graphical user interface.

15. A computer-implemented method for conducting an automated interview using a telephony system, comprising:
(a) establishing an interviewee telephone call;
(e) providing interview questions during the interviewee telephone call and recording at least a portion of the interviewee telephone call to generate an interview response file; and
(f) posting the interview response file on a computer implemented graphical interface to allow one or more interviewers to access the interview response file.

16. The method of claim 15, further including providing a comment function on the graphical user interface to allow the one or more interviewers to provide comments to be associated with the interview response file.

17. The method of claim 16, wherein the comment function is configured to implement an incremental rating system ranking the interview response file relative to other interview response files displayed on the computer-implemented graphical user interface.

18. The method of claim 16, wherein the comment function is configured to allow a user to initiate at least a third telephone call to provide additional audio content to be associated with the interview response file.

19. The method of claim 16, wherein the comment function is configured to increase or decrease an interviewee rating associated with the creator of the interview response.

20. The method of claim 15, further including receiving information to be associated with the interview response file through the graphical user interface.
